(19) United States
(12) Patent Application Publication
(10) Pub. No.: US 2022/0212633 A1
(43) Pub. Date: Jul. 7, 2022

(54) ADAPTIVE WIPING ELEMENTS FOR OPTICAL INTERFACES BASED ON VISUAL FEEDBACK

(71) Applicant: NEC Corporation Of America, Herzlia (IL)

(72) Inventor: Tsvi LEV, Tel-Aviv (IL)

(73) Assignee: NEC Corporation Of America, Herzlia (IL)

(21) Appl. No.: 17/142,343

(22) Filed: Jan. 6, 2021

(51) Int. Cl. B60S 1/08; G06K 9/00; G01S 17/89; G01S 13/89

(52) U.S. Cl. CPC B60S 1/0848; G06K 9/00791; G01S 13/89; G01S 17/89; B60S 1/0837

(57) ABSTRACT

A method for detecting non-rain and/or non-snow particles movement towards an optical interface is disclosed. The method comprises: receiving one or more images from one or more imaging sensors of the vicinity of the optical interface, of particles movement towards the optical interface; analyzing the one or more images to detect non-rain and/or non-snow particles movement towards the optical interface and distinguish between rain and/or snow particles and the non-rain and/or non-snow particles movement towards the optical interface; and controlling one or more wiping elements activation based on the analyzed one or more images and removing the non-rain and/or non-snow particles from the optical interface.

### FIELD AND BACKGROUND OF THE INVENTION

The present disclosure, in some embodiments thereof, relates to optical systems and, more specifically, but not exclusively, to adaptive wiping elements for optical interfaces based on a visual feedback.

Systems, which contain optical interfaces, such as: glasses, windows, mirrors and the like are required to meet high standard of cleanliness. This is, to enable a proper use of the optical interface. In order to keep the optical interface clean, the systems contain cleaning and wiping elements, which are activated once an undesired material and/or particle is detected on the surface of the optical interface. For example, a car windshield, should be clean, to allow a driver to drive and see the way and road properly. Therefore, the car contain wipers, which are activated by the driver once the driver recognizes materials and/or particles on the windshield of the car, which interfere with the driving and with seeing the road properly. The wipers in this case, are mechanical elements, which remove the interfering material and/or particles, by a semi circular movement of wiping on the surface of the windshield. Other devices like light detection and ranging (LIDAR) sensor, advance driver assistance system (ADAS) cameras, surveillance cameras and the like also need the wiping operation to keep on proper operation with high level of performance.

### SUMMARY OF THE INVENTION

It is an object of the present disclosure to describe a system and a method for detecting non-rain and/or non-snow particles movement towards an optical interface. The detection is based on images received from one or more imaging sensors of the vicinity of the optical interface.

It is a further object of the present disclosure to activate and control one or more wiping elements to remove the non-rain and/or non-snow particles from the vicinity of the optical interface and to prevent these particles from reaching and hitting the optical interface.

The foregoing and other objects are achieved by the features of the independent claims. Further implementation forms are apparent from the dependent claims, the description and the figures.

In one aspect, the present disclosure relates to a method for detecting non-rain and/or non-snow particles movement towards an optical interface. The method comprises:

receiving one or more images from one or more imaging sensors of the vicinity of the optical interface, of particles movement towards the optical interface; analyzing the one or more images to detect non-rain and/or non-snow particles movement towards the optical interface and distinguish between rain and/or snow particles and the non-rain and/or non-snow particles movement towards the optical interface; and controlling one or more wiping elements activation based on the analyzed one or more images and removing the non-rain and/or non-snow particles from the optical interface.

In a further implementation of the first aspect, the method, further comprises a computer implemented method for generating a model for detecting non-rain and/or snow particles movement towards the optical interface, comprising: receiving a plurality of visual information records each represents measurements taken by the one or more imaging sensors of the vicinity of the optical interface; training at least one model with the plurality of visual information records to detect non-rain and/or non-snow particles movements towards the optical interface; outputting the at least one model for detecting non-rain and/or snow particles movement towards an optical interface based on new measurements taken by other one or more imaging sensors, of the vicinity of another optical interface.

In a further implementation of the first aspect, the method, further comprises a computer implemented method for executing a model, for detecting non-rain and/or non-snow particles movement towards the optical interface, comprising: receiving a plurality of visual information records, each represents measurements taken by the one or more imaging sensors of the vicinity of the optical interface; executing at least one model to classify each of the plurality of records; detecting non-rain and/or non-snow particles movement towards the optical interface based on outputs of the execution of the at least one model; analyzing the received visual information records of the detected non-rain and/or non-snow measurements moving towards the optical interface; and controlling one or more wiping elements activation according to the analyzed visual information records of the non-rain and/or non-snow measurements moving towards the optical interface.

In a further implementation of the first aspect, controlling one or more wiping elements activation comprises controlling timing, intensity and directionality of the wiping elements and electrical voltage applied to the wiping elements. In this implementation, the control of the one or more wiping elements activation is done according to a feedback loop where images from the one or more imaging sensors continue to be received after the activation of the one or more wiping elements with a specific intensity, timing and directionality. In response, when the non-rain and/or non-snow particles are still detected and not removed, the activation of the one or more wiping elements is changed to be in a different intensity and/or directionality and/or timing, until the successful removal of the particles.

In a further implementation of the first aspect, analyzing the one or more images is done according to at least one of the following algorithms: change detection, optical flow, object detection and simultaneous localization and mapping (SLAM).

In a further implementation of the first aspect, the wiping elements are a member of the following list: wipers, air flow and ultrasound waves.

In a further implementation of the first aspect, the method further comprises detecting a hit of the non-rain and/or non-snow particles on the optical interface and activating the wiping element according to the analyzed images of the non-rain and/or non-snow moving towards the optical interface.

In a further implementation of the first aspect, the method further comprising detecting when the optical interface is clean and stopping the activation of the wiping elements accordingly.

In a further implementation of the first aspect, the method further comprising detecting when the optical interface is not clean and continuing the activation of the wiping elements accordingly.

In a further implementation of the first aspect, controlling the one or more wiping elements activation, when detecting the optical interface is not clean comprises changing the one or more wiping elements activated according to analyzed visual information records of the non-rain and/or non-snow measurements moving towards the optical interface accordingly.

In a further implementation of the first aspect, the one or more imaging sensors are stationary or located on a moving platform.

In a second aspect, the present disclosure relates to a system for detecting non-rain and/or non-snow particles movement towards an optical interface. The system is adapted to: receive one or more images from one or more imaging sensors of the vicinity of the optical interface, of particles movement towards the optical interface; analyze the one or more images to detect non-rain and/or non-snow particles movement towards the optical interface and distinguish between rain and/or snow particles and the non-rain and/or non-snow particles movement towards the optical interface; and control one or more wiping elements activation based on the analyzed one or more images and removing the non-rain and/or non-snow particles from the optical interface.

In a further implementation of the second aspect, the system is further adapted to generate a model for detecting non-rain and/or snow particles movement towards an optical interface, comprising at least one vision processor executing a code for:

receiving a plurality of visual information records each represents measurements taken by one or more imaging sensors of the vicinity of the optical interface;

training at least one model with the plurality of visual information records to detect non-rain and/or non-snow particles movements towards the optical interface;

outputting the at least one model for detecting non-rain and/or snow particles movement towards an optical interface based on new measurements taken by other one or more imaging sensors, of the vicinity of another optical interface.

In a further implementation of the second aspect, the system is further adapted to execute a model for detecting non-rain and/or non-snow particles movement towards an optical interface, comprising at least one vision processor executing a code for:

receiving a plurality of visual information records, each represents measurements taken by one or more imaging sensors of the vicinity of the optical interface;

executing at least one model to classify each of the plurality of records;

detecting non-rain and/or non-snow particles movement towards the optical interface based on outputs of the execution of the at least one model;

analyzing the received visual information records of the detected non-rain and/or non-snow measurements moving towards the optical interface; and

controlling one or more wiping elements activation according to the analyzed visual information records of the non-rain and/or non-snow measurements moving towards the optical interface.

In a further implementation of the second aspect, the one or more imaging sensors are members of a group consisting of: visible light camera, infra-red camera, radio detection and ranging (RADAR) sensor, and light detection and ranging (LIDAR) sensor.

In a further implementation of the second aspect, the optical interface is a member of a group consisting of: a glass, a window, a lens and a mirror.

In a further implementation of the second aspect, the non-rain and/or non-snow particles are members of a group consisting of: insects, sand, dust and dirt.

Unless otherwise defined, all technical and/or scientific terms used herein have the same meaning as commonly understood by one of ordinary skill in the art to which the disclosure pertains. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIG. 1 schematically shows a system for detecting non-rain and/or non-snow particles movement towards an optical interface according to some embodiments of the present disclosure;

FIG. 2 schematically shows a flow chart of a method for detecting non-rain and/or non-snow particles movement towards an optical interface according to some embodiments of the present disclosure;

FIG. 3 schematically shows a computer implemented method for generating a model for detecting non-rain and/or non-snow particles movement towards an optical interface, according to some embodiments of the present disclosure; and

FIG. 4 schematically shows a computer implemented method for executing a model for detecting non-rain and/or non-snow particles movement towards an optical interface, according to some embodiments of the present disclosure.

### DESCRIPTION OF SPECIFIC EMBODIMENTS OF THE INVENTION

The present disclosure, in some embodiments thereof, relates to optical systems and, more specifically, but not exclusively, to adaptive wiping elements for optical interfaces based on a visual feedback.

When in use in real world surroundings, optical devices may be affected by particles hitting, touching and sticking to their optical interface, such as: lenses, glasses, windows and the like. The particles on the optical interface interfere with the proper operation of the optical devices and impairs the field of view. The particles may include, for example, small insects, pollen, sand, dirt, dust, and more. The particles may also include raindrops and snow, however, a wide scale of wiping and removal mechanisms exist for removing raindrops and snow from optical interfaces and therefore, the present disclosure especially relates to the removal of non-rain and non-snow particles.

For keeping such optical interface surfaces clean, there exist various kind of wiping or particle removal mechanisms such as mechanical wiper, water sprinklers, air jets and the like.

As to non-rain and non-snow particles, the existing mechanism of wiping and/or particles removals mechanism usually are triggered either by a human operator or by some timer or simple particle sensor. Hence, for example, the wiping and/or particles removals mechanism may not be operating exactly at the time some particle arrives at the optical interface, and so the particles may stick to the optical interface, becoming harder to remove. In addition, the intensity of operation and directionality of the existing wiping and/or particles removals mechanism are not optimized to the incoming stream of particles.

Furthermore, the problem of unwanted particles is getting worse when it comes to internal optical components in large systems (e.g. mirrors in complex lab or industrial settings) that are difficult and/or time consuming to access by a human operator.

There is therefore a need to provide a solution for wiping and cleaning optical interfaces automatically without any human intervention, and eliminating the arrival of the particles to the optical interface when possible to prevent disturbances of particles on the surface of optical interfaces.

The present disclosure discloses a method and system for detecting non-rain and/or non-snow particles movement towards an optical interface based on a visual feedback received from an optical and/or imaging sensor. A closed loop system, using the visual information arriving from the imaging sensor (camera, infrared camera, lidar, radar) is analyzed to control the timing, intensity and directionality of the wiping elements and the electrical voltage applied to the wiping elements.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer and/or computerized device, partly on the user's computer and/or computerized device, as a stand-alone software package, partly on the user's computer (and/or computerized device) and partly on a remote computer or entirely on the remote computer or server. In the latter scenario, the remote computer may be connected to the user's computer and/or computerized device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

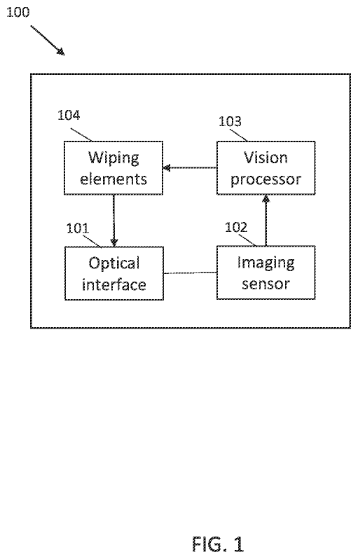

Reference is now made to FIG. 1, which schematically shows a system for detecting non-rain and/or non-snow particles movement towards an optical interface according to some embodiments of the present disclosure. System 100, includes an optical interface 101, on or more imaging sensors 102, a vision processor 103 and one or more wiping elements 104. The optical interface 101 may be a glass, a lens, a window and the like. The optical interface is monitored by the imaging sensor 102, which takes images of the vicinity of the optical interface and of the optical interface itself to detect non-rain and/or non-snow particles movement toward the optical interface. The imaging sensor may be for example a visible light camera (including a video camera), infra-red (IR) camera, radio detection and ranging (RADAR) sensor, light detection and ranging (LIDAR) sensor and the like. According to some embodiments of the present disclosure, special lighting (constant or switchable) sources may be used to allow the imaging sensor to better detect the no-rain and/or non-snow particles. For example, strong short range IR light, side lights, strobe lights and anything which may assist in verifying the particles existence, nature, speed, direction and other features as well.

The images taken by imaging sensors 102 are provided to the vision processor 103 for analysis to detect non-rain and non-snow particles movement toward the optical interface 101. According to some embodiments of the present disclosure, the vision processor 103, activates and controls the activation of the one or more wiping elements 104 based on the analysis of the one or more images provided by the one or more imaging sensors 102. The wiping elements 104 are activated and controlled to remove the non-rain and/or non-snow particles from the vicinity of the optical interface, before it touches the optical interface when possible, and of course to remove the non-rain and/or non-snow particles from the optical interface 101, in case the particles reaches the optical interface.

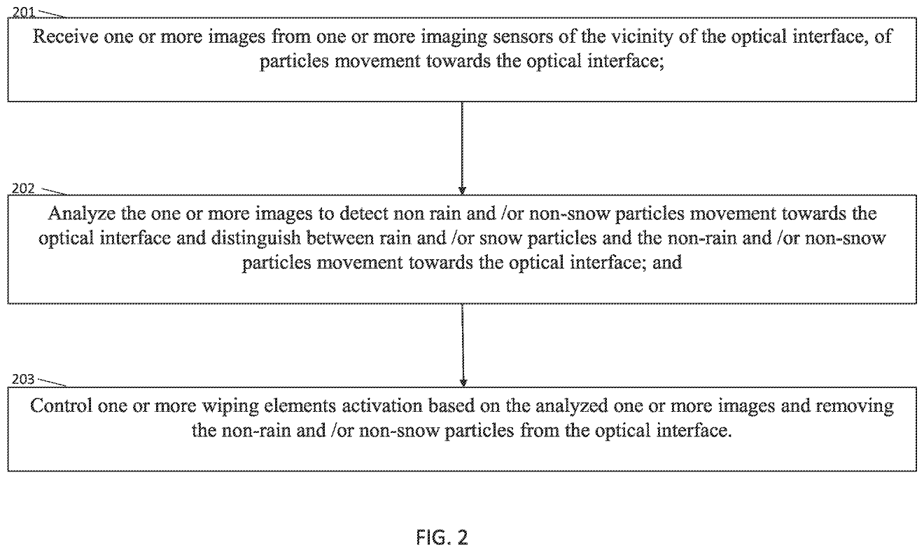

Reference is now made to FIG. 2, which schematically shows a flow chart of a method for detecting non-rain and/or non-snow particles movement towards an optical interface according to some embodiments of the present disclosure. At 201, the vision processor 103 receives one or more images from one or more imaging sensors 102 of the optical interface 101 and the vicinity of the optical interface 101. At 202, the vision processor 103, executes a code that analyzes the received images to detect non-rain and/or non-snow particles movement toward the optical interface 101. The analysis may distinguish between different types of particles moving together in a jumble and detect every type of particle separately. For example, when raindrops and dust are moving together toward the optical interface, the one or more imaging sensor 102 takes images of the jumble of dust and raindrops and the vision processor 103 analyzes the images and detects the two types of particles as raindrops and dust. In some embodiments of the present disclosure, the analysis of the images is done by one or more of the following algorithms: change detection, optical flow, object detection and simultaneous localization and mapping (SLAM), or a combination thereof. In addition, different tracking algorithms may be used. Using tracking algorithms, it is possible to deduce over time the direction and speed of the particle flow, and hence calculate the optimal intensity, direction and time behavior (pulse/continuous/pulse timing and strength). Using a change detection algorithm it may be possible to detect when some particles did stick to the optical interface despite the efforts to prevent the non-rain and/or non-snow to reach the optical interface. In that case, the vision processor may attempt various actions to gauge their success in moving the stuck particle and thus be more effective in pushing it outside of the field of view (FOV) in the optical interface. In some embodiments of the present disclosure, in case one or more of the imaging sensors 102 may be LIDAR or a video camera. In this case, the coordination between the wiper operation timing and the visual particle flow may be used to determine the precise frames in a video and/or the time slots in the LIDAR operation in which to take a measurement and/or photo or the parts of the FOV in each time step, which are relatively clear.

The vision processor 103, detects small yet fast moving particles near the imaging sensor optical aperture and differentiates between the different types of particles, and distant objects which are moving. Thus, according to some embodiments of the present disclosure, the vision processor detects the need to apply wiping elements before the non-rain and/or non-snow particles reach and/or stick and/or dry on the optical interface. The wiping elements may be any element that is capable of removing non-rain and/or non-snow particles in different types of technologies. For example, wipers, air flow, ultrasound waves and the like. In some embodiments of the present disclosure, the vision processor 103 also detects a hit of non-rain and non-snow on the optical interface 101, and activates and controls accordingly one or more wiping elements to remove the non-rain and/or snow particles from the optical interface 101.

At 203, in case non-rain and/or non-snow particles are detected, the vision processor 103, activates one or more wiping elements 104, and controls the activation of the wiping elements to remove the detected non-rain and/or non-snow particles from the vicinity of the optical interface 101, or when the particles reach the optical interface 101, to remove them from the optical interface. The vision processor 103, activates the wiping elements 104 and control them to optimally remove the non-rain and/or no-snow particles from vicinity of the optical interface 101, or from the optical interface 101 in case the particles reached the optical interface 101 surface. According to some embodiments of the present disclosure, the vision processor 103, controls the timing, intensity and directionality of the one or more wiping elements 104. The vision processor 103 also controls the electrical voltage applied to the one or more wiping elements. Once the vision processor detects that the optical interface is clean and the vicinity of the optical interface is also clean from non-rain and/or non-snow particles movement toward the optical interface, the vision processor 103 stops the activation of the one or more wiping elements. However, as long as the vision processor detects that the optical interface 101, and/or the vicinity of the optical interface is not clean from non-rain and/or non-snow particles, the vision processor keeps activating and controlling the one or more wiping elements 104. The activation and control of the one or more wiping elements is based on the analysis of the constantly received images and optical information record from the one or more imaging sensors 102. For example, when the vision processor 103 detects non-rain and/or non-snow particles on the optical interface 101 and then activates one or more wiping elements 104 with a specific intensity and at a first direction. When the images from the one or more imaging sensors 102 continue to be received after the activation of the one or more wiping elements 104, show that the particles are not removed, the vision processor 103 may change the activation of the one or more wiping element. For example by increasing the intensity of the wiping element and changing the direction to a second direction, or changing the timing of activation to be longer or changing the activation pattern of the one or more wiping elements from pulses to continuous activation and so on, until the particles are successfully removed.

According to some embodiments of the present disclosure, the one or more imaging sensors 102 may be locates on a moving platform, such as cars, drowns and the like. According to some other embodiments of the present disclosure, the imaging sensors 102 are stationary.

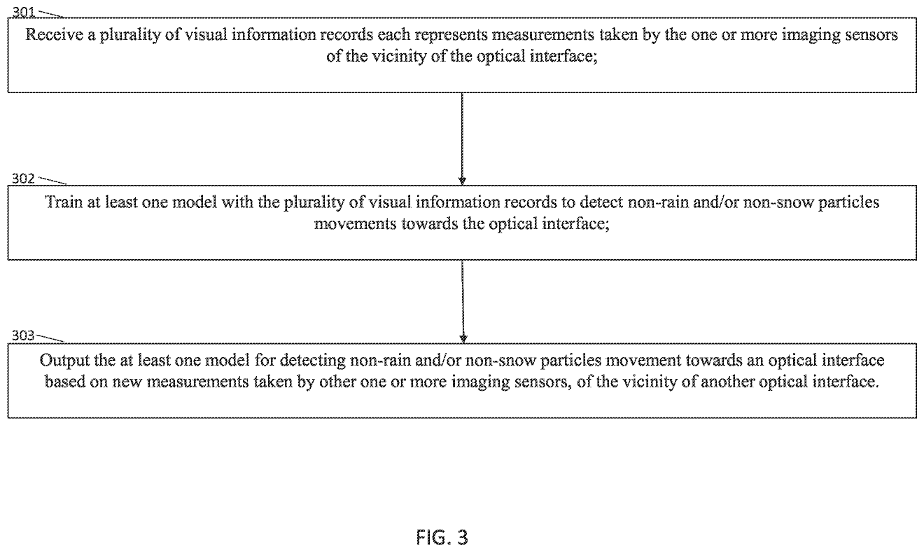

According to some embodiments of the present disclosure, the analysis of the images, which are received from the one or more imaging sensors 102, is done based on a machine learning technique. This is, by training a model to detect non-rain and/or non-snow particles movement in the vicinity of an optical interface, and executing the trained model to detect non-rain and/or non-snow particles movement of the vicinity of an optical interface. FIG. 3, schematically describes a computer implemented method for generating a model for detecting non-rain and/or non-snow particles movement towards an optical interface, according to some embodiments of the present disclosure. At 301, the vision processor 103 receives a plurality of visual information records each represents measurements based on images taken by the one or more imaging sensors of the vicinity of the optical interface. At 302, the vision processor 103 trains at least one model with the plurality of visual information records to detect non-rain and/or non-snow particles movements towards the optical interface. The model is also trained to distinguish between non-rain and/or non-snow particles and between rain and/or snow particles, and to detect every type of particle separately. At 303, the vision processor 103 outputs the at least one model for detecting non-rain and/or snow particles movement towards an optical interface based on new measurements taken by other one or more imaging sensors, of the vicinity of another optical interface.

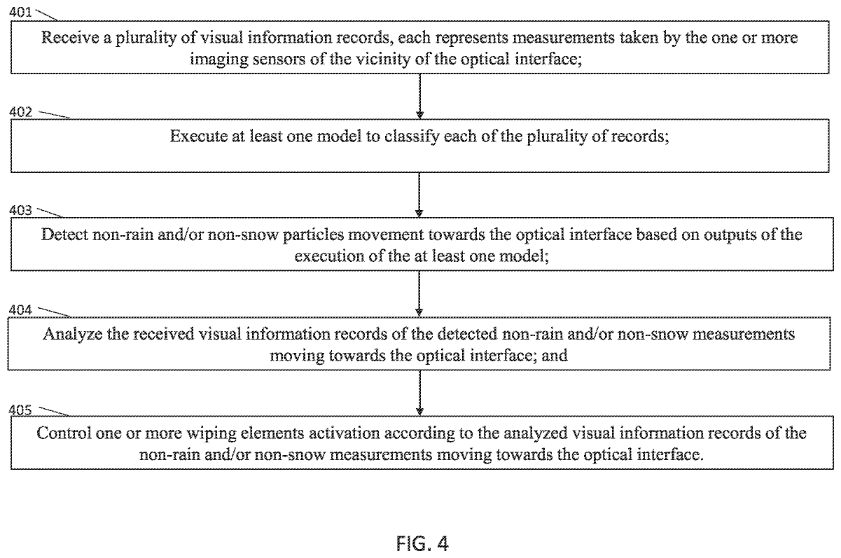

FIG. 4 schematically describes a computer implemented method for executing a model for detecting non-rain and/or snow particles movement towards an optical interface, according to some embodiments of the present disclosure. At 401, the vision processor 103, receives a plurality of visual information records each represents measurements based on images taken by the one or more imaging sensors 102 of the vicinity of the optical interface. At 402, the vision processor 103, executes at least one model to classify each of the plurality of records, to detect non-rain and/or non-snow particles movement toward the optical interface. At 403, the vision processor 103, detects non-rain and/or non-snow particles movements towards the optical interface 101, based on the output of the execution of the at least one model. At 404, the vision processor 103, analyses the received visual records of the detected non-rain and/or non-snow measurements moving towards the optical interface 101. Finally, at 405, the vision processors 103 activates one or more wiping elements 104, and controls the activation of the wiping elements 104, according to the analyzed visual information records of the non-rain and/or non-snow measurements moving towards the optical interface. The activation of the one or more wiping elements 104, by the vision processor 103, includes selecting the one or more wiping elements that are most suitable to remove the detected non-rain and/or non-snow particles and controlling the activation of the selected wiping elements in terms of the timing, intensity and directionality. In addition controlling the activation of the one or more wiping elements includes controlling the electrical voltage applied to the one or more wiping elements activated. Controlling the timing of the one or more wiping elements means, when exactly to start the activation of the one or more wiping element, for how long and activating it continuously or intermittently. In case the wiping element is activated intermittently, the vision processor calculates the duration of the time intervals activation and the duration of pauses between the time intervals activations. Also, the vision processor 103, keeps receiving feedback from the one or more imaging sensors of images of the vicinity of the optical interface. In response to the received feedback of images from the one or more imaging sensors 102, the vision processor adapts the activation and the control of the one or more wiping elements 104 to the real time situation of the optical interface 101 and to the real time situation of the vicinity of the optical interface. According to some embodiments of the present disclosure, the vision processor may change the selection of the one or more wiping elements, according to the continuous feedback of images received from the one or more imaging sensor. The vision processor 103 may activate different one or more wiping elements from the one or more wiping elements selected before. The intensity and directionality of the activation of the one or more wiping elements are also controlled by the vision processor 103. The vision processor 103 may increase or decrease the intensity of the activation of the one or more wiping elements and change the direction of activation of the one or more wiping elements (all the elements or just one or some of the wiping elements) according to the received feedback from the one or more imaging sensors.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems for detecting non-rain and/or non-snow particles movement towards an optical interface will be developed and the scope of the term methods and systems for detecting non-rain and/or non-snow particles movement towards an optical interface is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Throughout this application, various embodiments of this disclosure may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for detecting non-rain and/or non-snow particles movement towards an optical interface, comprising:
receiving one or more images from one or more imaging sensors of the vicinity of the optical interface, of particles movement towards the optical interface;
analyzing the one or more images to detect non-rain and/or non-snow particles movement towards the optical interface and distinguish between rain and/or snow particles and the non-rain and/or non-snow particles movement towards the optical interface; and
controlling one or more wiping elements activation based on the analyzed one or more images and removing the non-rain and/or non-snow particles from the optical interface.

2. The method of claim 1, further comprising a computer implemented method for generating a model for detecting non-rain and/or snow particles movement towards the optical interface, comprising:
receiving a plurality of visual information records each represents measurements taken by the one or more imaging sensors of the vicinity of the optical interface;
training at least one model with the plurality of visual information records to detect non-rain and/or non-snow particles movements towards the optical interface;
outputting the at least one model for detecting non-rain and/or snow particles movement towards an optical interface based on new measurements taken by other one or more imaging sensors, of the vicinity of another optical interface.

3. The method of claim 1, further comprising a computer implemented method for executing a model, for detecting non-rain and/or non-snow particles movement towards the optical interface, comprising:
receiving a plurality of visual information records, each represents measurements taken by the one or more imaging sensors of the vicinity of the optical interface;
executing at least one model to classify each of the plurality of records;
detecting non-rain and/or non-snow particles movement towards the optical interface based on outputs of the execution of the at least one model;
analyzing the received visual information records of the detected non-rain and/or non-snow measurements moving towards the optical interface; and
controlling one or more wiping elements activation according to the analyzed visual information records of the non-rain and/or non-snow measurements moving towards the optical interface.

4. The method of claim 1, wherein controlling one or more wiping elements activation comprises controlling timing, intensity and directionality of the wiping elements, and electrical voltage applied to the wiping elements.

5. The method of claim 1, wherein analyzing the one or more images is done according to at least one of the following algorithms: change detection, optical flow, object detection and simultaneous localization and mapping (SLAM).

6. The method of claim 1, wherein the wiping elements are a member of the following list: wipers, air flow and ultrasound waves.

7. The method of claim 1, further comprising detecting a hit of the non-rain and/or non-snow particles on the optical interface and activating the wiping element according to the analyzed images of the non-rain and/or non-snow moving towards the optical interface.

8. The method of claim 7, further comprising detecting when the optical interface is clean and stopping the activation of the wiping elements accordingly.

9. The method of claim 7, further comprising detecting when the optical interface is not clean and continuing the activation of the wiping elements accordingly.

10. The method of claim 9, wherein controlling the one or more wiping elements activation, when detecting the optical interface is not clean comprises changing the one or more wiping elements activated according to analyzed visual information records of the non-rain and/or non-snow measurements moving towards the optical interface accordingly.

11. The method of claim 1, wherein the one or more imaging sensors are stationary or located on a moving platform.

12. A system for detecting non-rain and/or non-snow particles movement towards an optical interface, adapted to:
receive one or more images from one or more imaging sensors of the vicinity of the optical interface, of particles movement towards the optical interface;
analyze the one or more images to detect non-rain and/or non-snow particles movement towards the optical interface and distinguish between rain and/or snow particles and the non-rain and/or non-snow particles movement towards the optical interface; and
control one or more wiping elements activation based on the analyzed one or more images and removing the non-rain and/or non-snow particles from the optical interface.

13. The system of claim 12, further adapted to generate a model for detecting non-rain and/or snow particles movement towards an optical interface, comprising at least one vision processor executing a code for:
receiving a plurality of visual information records each represents measurements taken by one or more imaging sensors of the vicinity of the optical interface;
training at least one model with the plurality of visual information records to detect non-rain and/or non-snow particles movements towards the optical interface;
outputting the at least one model for detecting non-rain and/or snow particles movement towards an optical interface based on new measurements taken by other one or more imaging sensors, of the vicinity of another optical interface.

14. The system of claim 12, further adapted to execute a model for detecting non-rain and/or non-snow particles movement towards an optical interface, comprising at least one vision processor executing a code for:
receiving a plurality of visual information records, each represents measurements taken by one or more imaging sensors of the vicinity of the optical interface;
executing at least one model to classify each of the plurality of records;
detecting non-rain and/or non-snow particles movement towards the optical interface based on outputs of the execution of the at least one model;
analyzing the received visual information records of the detected non-rain and/or non-snow measurements moving towards the optical interface; and
controlling one or more wiping elements activation according to the analyzed visual information records of the non-rain and/or non-snow measurements moving towards the optical interface.

15. The system of claim 12, wherein the one or more imaging sensors are members of a group consisting of: visible light camera, infra-red camera, radio detection and ranging (RADAR) sensor, and light detection and ranging (LIDAR) sensor.

16. The system of claim 12, wherein the optical interface is a member of a group consisting of: a glass, a window, a lens and a mirror.

17. The system of claim 12, wherein the non-rain and/or non-snow particles are members of a group consisting of: insects, sand, dust and dirt.
